(19) United States
(12) Patent Application Publication
(10) Pub. No.: US 2008/0063815 A1
(43) Pub. Date: Mar. 13, 2008

(54) LIQUID CRYSTAL COMPOSITION AND LIQUID CRYSTAL DISPLAY COMPRISING THE SAME

(75) Inventors: Hyun-Wuk Kim, Yongin-si (KR); Fusayuki Takeshita, Seoul (KR); Jae-Jin Lyu, Yongin-si (KR); Keun Chan Oh, Suwon-si (KR); Yong-Kuk Yun, Suwon-si (KR); Jong-Ho Son, Seoul (KR); Jang-Hyun Kim, Seoul (KR); Min-Goo Seok, Yongin-city (KR); Sik-Young Jo, Yesan-gun (KR)

Correspondence Address: MACPHERSON KWOK CHEN & HEID LLP, 2033 GATEWAY PLACE, SUITE 400, SAN JOSE, CA, 95110, US

(73) Assignee: SAMSUNG ELECTRONICS CO., LTD, Suwon-Si (KR)

(21) Appl. No.: 11/854,737

(22) Filed: Sep. 13, 2007

(30) Foreign Application Priority Data
Sep. 13, 2006 (KR) 10-2006-0088447

(51) Int. Cl. C09K 19/30; C09K 19/10

(52) U.S. Cl. 428/1.5; 252/299.63; 252/299.66

(57) ABSTRACT

A liquid crystal composition includes a first class including a liquid crystal compound having at least two fluorine atoms, and a second class including a liquid crystal compound that has a single fluorine atom or that does not have a fluorine atom. The first and second classes include liquid crystal compounds expressed by various chemical formulas. A liquid crystal display including the liquid crystal composition is also provided.

### CROSS-REFERENCE TO RELATED APPLICATION

This application claims priority to and the benefit of Korean Patent Application No. 10-2006-0088447 filed in the Korean Intellectual Property Office on Sep. 13, 2006, the entire contents of which are incorporated herein by reference.

### BACKGROUND OF THE INVENTION

(a) Field of the Invention

The present invention relates to a liquid crystal composition and a liquid crystal display (LCD) comprising the same.

(b) Description of the Related Art

The LCD is one of the most commonly used flat panel displays. The LCD includes two display panels in which field generating electrodes such as pixel electrodes and common electrodes are formed, and a liquid crystal layer interposed therebetween. In the LCD, a voltage is applied to the field generating electrodes to generate an electric field on the liquid crystal layer to thereby determine a direction of liquid crystal molecules of the liquid crystal layer and control transmittance of light that passes through the liquid crystal layer.

Of the LCD, liquid crystals are critical factors to obtain a desired image by controlling the light transmittance. In particular, as the LCD is applied to diverse purposes in various fields, it is expected to have various characteristics that it should be driven at a low voltage and have a high voltage holding ratio (VHR), a wide viewing angle, a wide operational temperature range, a fast response time, etc.

In order to satisfy the diverse characteristics, the liquid crystal layer includes a liquid crystal composition in which various types of liquid crystal molecules are included.

However, because the liquid crystal composition comprises various types of high-priced liquid crystal molecules, its burden of cost is high. Omission of some of the liquid crystal molecules to reduce the material unit cost would deteriorate some characteristics of the liquid crystal, negatively influencing reliability of the liquid crystal composition.

The liquid crystal layer contains a large amount of ion impurities in addition to the liquid crystal composition. The ion impurities may be laterally transported along an electric field generated in the liquid crystal layer so as to be concentrated at a particular portion such as the boundary of a field generating electrode. In this case, the ion impurity-concentrated portion may disadvantageously appear as a residual image.

### SUMMARY OF THE INVENTION

The present invention has been made in an effort to provide a liquid crystal composition and a liquid crystal display (LCD) comprising the same having advantages of obtaining reliability of liquid crystal molecules while reducing a cost for a liquid crystal material. The present invention has been also made in an effort to prevent generation of a residual image of an LCD.

An embodiment of the present invention provides a liquid crystal composition comprising a first class including a liquid crystal compound having at least two fluorine atoms, and a second class including a liquid crystal compound that has a single fluorine atom or that does not have a fluorine atom. The first class includes liquid crystal compounds expressed by Chemical Formulas I and II shown below:

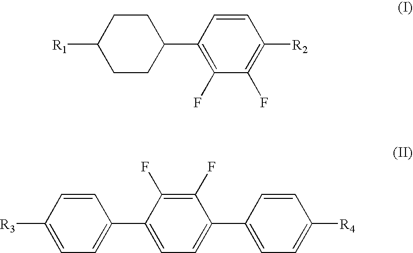

The second class includes at least one of liquid crystal compounds expressed by Chemical Formulas III and IV shown below:

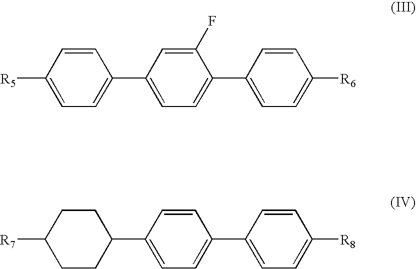

The liquid crystal compounds expressed by Chemical Formulas I and II have R₁ to R₄ as a terminal group, where each of R₁ to R₄ is one of a C₁ to C₁₀ alkyl group and alkoxy group, and the liquid crystal compounds expressed by Chemical Formulas III and IV have R₅ to R₈ as a terminal group, where each of R₅ to R₈ is one of a C₁ to C₁₀ alkyl group, an alkoxy group, and an alkenyl group.

Another embodiment of the present invention provides an LCD including a first substrate, a second substrate facing the first substrate, a pair of field generating electrodes formed on at least one of the first and second substrates, and a liquid crystal layer interposed between the first and second substrates. The liquid crystal layer comprises a first class including a liquid crystal compound that has at least two fluorine atoms and a second class including a liquid crystal compound that has one fluorine atom or that does not have a fluorine atom, and the first class includes liquid crystal compounds expressed by Chemical Formulas I and II and the second class includes at least one of liquid crystal compounds expressed by Chemical Formulas III and IV.

### BRIEF DESCRIPTION OF THE DRAWINGS

FIG. 1 is a layout view of a thin film transistor (TFT) array panel of a liquid crystal display (LCD) according to an embodiment of the present invention.

FIG. 2 is a layout view of a common electrode panel of the LCD according to the embodiment of the present invention.

FIG. 3 is a layout view of the LCD including the TFT array panel of FIG. 1 and the common electrode panel of FIG. 2.

FIGS. 4 and 5 are cross-sectional views taken along lines IV-IV and V-V of the LCD in FIG. 3.

### DETAILED DESCRIPTION OF THE EMBODIMENTS

A liquid crystal composition according to an embodiment of the present invention will now be described.

The liquid crystal composition includes many kinds of liquid crystal compounds, each with different physical properties.

Liquid crystal includes a core group that forms a central axis, and a terminal group and/or lateral group connected to the core group. The core group may include one or more cyclic compounds selected from a phenyl group, a cyclohexyl group, and heterocycles. The terminal group and the lateral group may include a non-polar group such as an alkyl group, an alkoxy group, and an alkenyl group, or a polar group such as a fluorine atom.

The liquid crystal composition according to the embodiment of the present invention includes a liquid crystal compound (referred to hereinafter as a “polar compound”) that has dielectric anisotropy and a liquid crystal compound (referred to hereinafter as a “neutral compound”) that does not have dielectric anisotropy.

The polar compound has dielectric anisotropy and refractive anisotropy, and at least two or more fluorine atoms (F) in the lateral group.

The polar compound may include liquid crystal compounds expressed by Chemical Formulas I, II, V, and VI shown below.

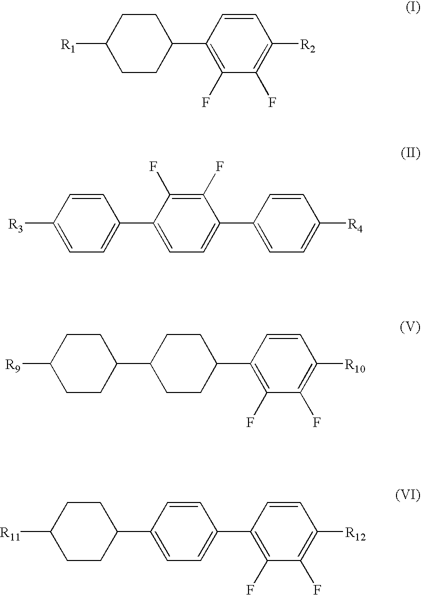

Herein, each of R₁ to R₄ and R₉ to R₁₂ may be the same or different, and may be one selected from an alkyl group and an alkoxy group having C₁ to C₁₀, respectively.

Preferably, the liquid crystal compound expressed by Chemical Formula I may be included at about 20 wt % to about 40 wt % of a total content of the liquid crystal composition, and the liquid crystal compound expressed by Chemical Formula II may be included at about 1 wt % to about 15 wt % of the total content of the liquid crystal composition. Preferably, the liquid crystal compounds expressed by Chemical Formulas V and VI may be included at about 40 wt % or less and about 20 wt % or less of the total content of the liquid crystal composition, respectively.

The liquid crystal compounds expressed by Chemical Formulas V and VI have high dielectric anisotropy and refractive anisotropy, but because they are high-priced, an increase in their content would increase the cost of the liquid crystal material.

Thus, in the embodiment of the present invention, a liquid crystal compound expressed as Chemical Formula II is provided as a substitute for the high-priced liquid crystal ingredients. The liquid crystal compound expressed by Chemical Formula II is relatively low-priced but has high dielectric anisotropy and refractive anisotropy.

Accordingly, the content of the liquid crystal compounds expressed by Chemical Formulas V and VI can be reduced and the liquid crystal compound expressed by Chemical Formula II is instead included at about 1 wt % to about 15 wt % and preferably at about 5 wt % to about 12 wt % to sustain the same level of dielectric anisotropy and refractive anisotropy as in the related art.

The polar compound can be included at about 10 wt % to about 90 wt % of the total content of the liquid crystal composition.

The neutral compound appropriately sustains viscosity of liquid crystal composition with the refractive anisotropy, and may include a compound that includes a lateral group that has a single fluorine atom or that does not have a fluorine atom.

The neutral compound may include at least one selected from Chemical Formulas III, IV, VII, VIII, IX, X, and XI.

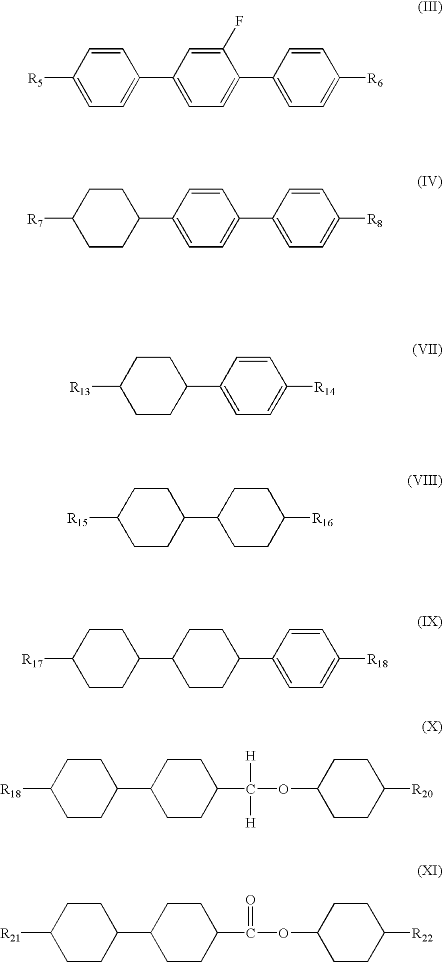

Herein, each of R₅ to R₈ and R₁₃ to R₂₂ may be the same or different, and may be one selected from an alkyl group, an alkoxy group, and an alkenyl group having C₁ to C₁₀.

Preferably, the liquid crystal compounds expressed by Chemical Formulas III and IV are included at about 15 wt % or less of the total content of the liquid crystal composition, respectively, and the liquid crystal compounds expressed by Chemical Formulas VII, VIII, IX, X, and XI are included at about 20 wt % or less, about 30 wt % or less, about 25 wt % or less, about 20 wt % or less, and about 10 wt % or less of the total content of the liquid crystal composition, respectively.

Of them, the liquid crystal compounds expressed by Chemical Formulas III and IV are relatively low-priced and have high refractive anisotropy, so they can complement the refractive anisotropy when the content of the liquid crystal compounds expressed by Chemical Formulas V and VI are reduced.

Preferably, the neutral compound is included at about 10 wt % to about 90 wt % of the total content of the liquid crystal composition.

When the alkenyl group is contained in at least one of R₅ to R₈ and R₁₃ to R₂₂, preferably, a neutral compound having the alkenyl group is included at about 7 wt % or less of the total content of the liquid crystal composition, and more preferably a neutral compound having the alkenyl group is not included.

According to the embodiment of the present invention, content of the neutral compound having the alkenyl group in the terminal groups R₅ to R₈ and R₁₃ to R₂₂ is limited. Namely, the liquid crystal composition does not include the neutral compound having the alkenyl group in the terminal group, and if it does, the liquid crystal composition includes the neutral compound at about 7 wt % or less of the total content of the liquid crystal composition.

When the alkenyl group is included in the terminal group of the neutral compound, a double-bond position of the alkenyl group may be a reaction site of ion impurities. Accordingly, the ion impurities are combined at the terminal group of the neutral compound and remain as is even after the liquid crystal composition is prepared. When the liquid crystal display (LCD) is driven, the ion impurities are laterally transported along an electric field generated in a liquid crystal layer and positioned at a particular portion such as the boundary of a field generating electrode, and when the ion impurities are combined with liquid crystal molecules, the refractive anisotropy changes to cause a line residual image.

Thus, in the embodiment of the present invention, the neutral compound having the alkenyl group in the terminal group is limited to reduce the reaction with the ion impurities to thus reduce changing of the refractive anisotropy of the liquid crystal composition by the ion impurities, thereby improving the line residual image characteristics.

The line residual image can be evaluated as follows.

First, a test display including two panels with field generating electrodes formed therein and a liquid crystal layer interposed therebetween is prepared. A plurality of pixels are disposed in the test display. Among the plurality of pixels, some pixels disposed horizontally and vertically in turn are represented with black and the others with white to set latticed black/white patterns. Next, after a predetermined time, the black/white patterns are removed, and it is checked whether line-shaped stains are recognized at the boundaries of each pixel while changing the entire test display with uniform gray levels from black to white. Time taken for the line-shaped stain to be visible (referred to hereinafter as “line residual image manifested time”) is measured. The line residual image manifested time is used as a reference for indicating how long the LCD can be driven without the line residual image, and the longer the line residual image manifested time, the better the line residual image characteristics are.

Experimentation results show that, without the neutral compound having the alkenyl group in the terminal group, the line residual image manifested time was about 3000 hours. In comparison, it was noted that as the neutral compound having the alkenyl group in the terminal group increased, the line residual image manifested time was considerably shortened, and in particular, when the content of the neutral compound having the alkenyl group in the terminal group exceeded about 7 wt %, the line residual image manifested time was reduced to less than 2000 hours.

Thus, according to an embodiment of the present invention, when the neutral compound having the alkenyl group in the terminal group is included at about 7 wt % or less of the total content of the liquid crystal composition, a line residual image manifested time of 2000 hours or longer can be obtained.

According to the embodiment of the present invention as described above, it was ascertained that the liquid crystal composition having the above-mentioned liquid crystal molecules satisfies the dielectric anisotropy of about −2.7 to −5.8, the refractive anisotropy of 0.075 to 0.109, and rotation viscosity of 87 mPa·s to 165 mPa·s.

Therefore, in place of the related art high-priced liquid crystal compounds, the relatively low-priced liquid crystal compounds can be substitutively included at an appropriate rate to obtain the desired dielectric anisotropy and refractive anisotropy.

In the following detailed description, only certain embodiments of the present invention have been shown and described, simply by way of illustration. As those skilled in the art would realize, the described embodiments may be modified in various different ways, all without departing from the spirit or scope of the present invention.

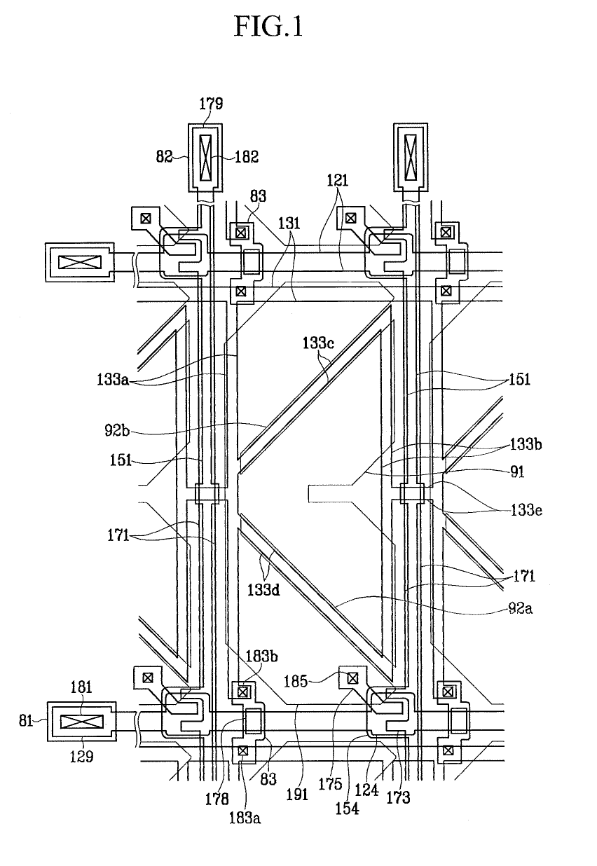

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. The LCD according to an embodiment of the present invention will now be described in detail with reference to FIGS. 1 to 5.

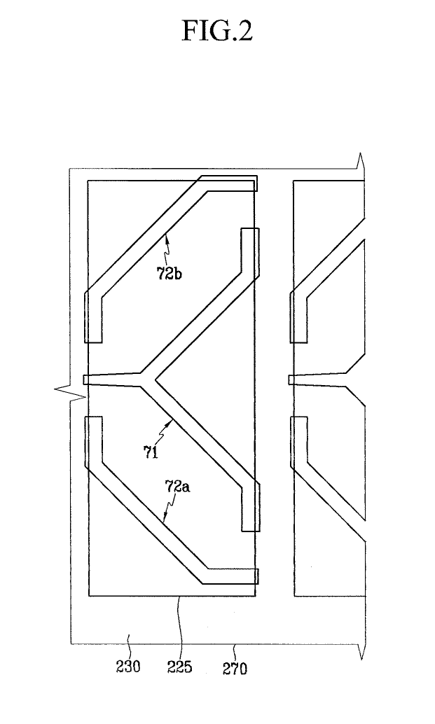

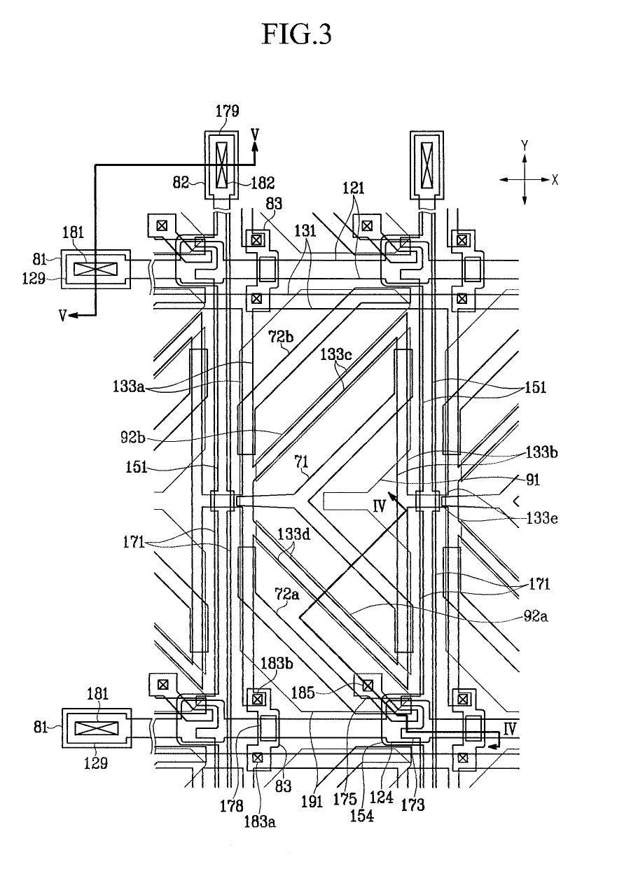

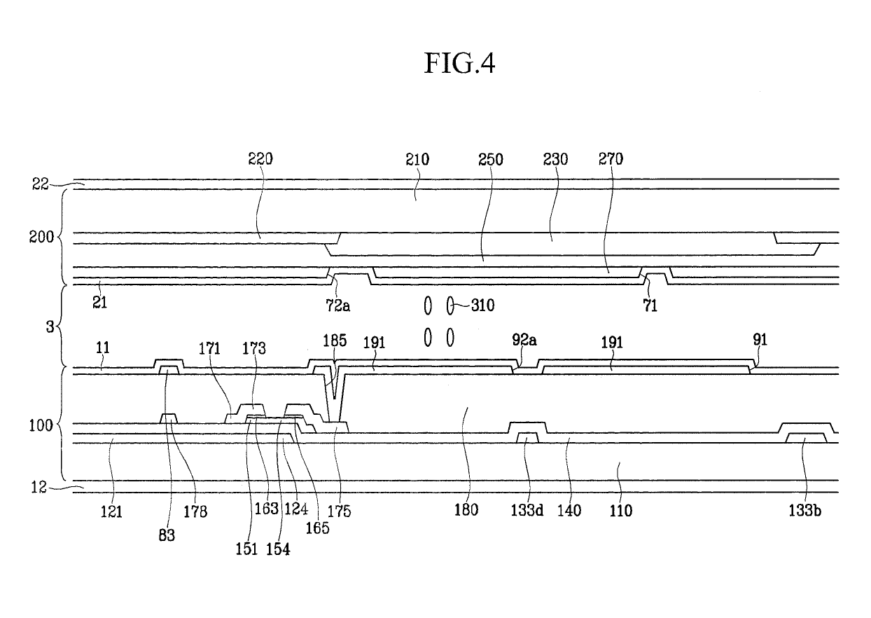

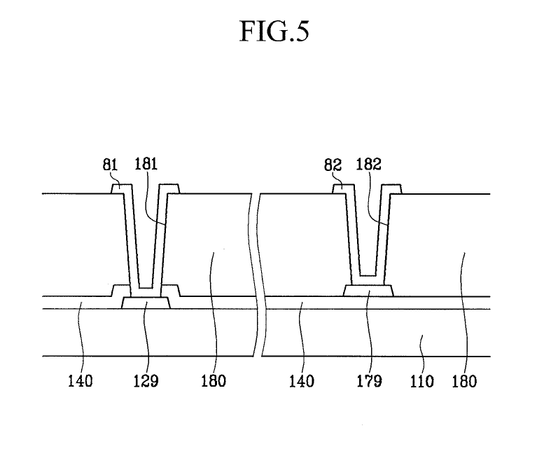

FIG. 1 is a layout view of a thin film transistor (TFT) array panel of a liquid crystal display (LCD) according to an embodiment of the present invention, FIG. 2 is a layout view of a common electrode panel of the LCD according to an embodiment of the present invention, FIG. 3 is a layout view of the LCD including the TFT array panel of FIG. 1 and the common electrode panel of FIG. 2, and FIGS. 4 and 5 are cross-sectional views taken along lines IV-IV and V-V of the LCD in FIG. 3.

With reference to FIGS. 1 to 5, the LCD according to the embodiment of the present invention includes a TFT array panel 100 and a common electrode panel 200 that face each other, and a liquid crystal layer 3 interposed between the two display panels 100 and 200.

First, the TFT array panel 100 will be described with reference to FIGS. 1, 3, 4, and 5.

A plurality of gate lines 121 and a plurality of storage electrode lines 131 are formed on an insulating substrate 110 made of transparent glass or plastic.

The gate lines 121 transfer gate signals and extend substantially in a horizontal direction. Each gate line includes a plurality of gate electrodes 124 that are protruded upward and a large end portion 129 for a connection with a different layer or an external driving circuit. A gate driving circuit (not shown) for generating gate signals can be mounted on a flexible printed circuit film (not shown) attached on the substrate 110, directly mounted on the substrate 110, or integrated on the substrate 110. When the gate driving circuit is integrated on the substrate 110, the gate lines 121 can be elongated to be directly connected thereto.

The storage electrode lines 131 receive a certain voltage, and include a branch line extending substantially parallel to the gate lines 121, a plurality of sets of first to fourth storage electrodes 133a, 133b, 133c, and 133d, and a plurality of connections 133e. The storage electrode lines 131 are disposed between two adjacent gate lines 121, respectively, and the branch line is closer to the upper one of the two gate lines 121.

The first and second storage electrodes 133a and 133b extend in a vertical direction and face each other. The first storage electrode 133a includes a fixed terminal connected with the branch line and a free end at the opposite side thereof, and the free end includes a protrusion. The third and fourth storage electrodes 133c and 133d extend substantially diagonally from the center of the first storage electrode 133a to lower and upper ends of the second storage electrode 133b. The connection 133e is connected between the adjacent sets of storage electrodes 133a to 133d. The shape and disposition of the storage electrode line 131 can be modified in various manners.

The gate lines 121 and the storage electrode lines 131 may be made of a low resistive conductor such as an aluminum-containing metal such as aluminum (Al) or an aluminum alloy, a silver-containing metal such as silver (Ag) or a silver alloy, a copper-containing metal such as copper (Cu) or a copper alloy, a molybdenum-containing metal such as molybdenum (Mo) or a molybdenum alloy, or metals such as chromium (Cr), tantalum (Ta), titanium (Ti), etc. Also, the gate lines 121 and the storage electrode lines 131 may have a multi-layered structure including two conductive layers (not shown) each having different physical properties.

The sides of the gate lines 121 and the storage electrode lines 131 may be sloped to the surface of the substrate 110, and preferably, the slope angle is within the range of about 30° to about 80°.

A gate insulating layer 140 made of silicon nitride (SiNx) or silicon oxide (SiO₂), etc., is formed on the gate lines 121 and the storage electrode lines 131.

A plurality of semiconductor stripes 151 made of hydrogenated amorphous silicon (a-Si) or polycrystalline silicon, etc., are formed on the gate insulating layer 140. The semiconductor stripes 151 extend substantially in a vertical direction and include a plurality of projections 154 extending toward the gate electrodes 124.

A plurality of ohmic contacts stripes and islands 161 and 165 are formed on the semiconductor stripes 151. The ohmic contact stripes and islands 161 and 165 can be made of a material such as n+ hydrogenated amorphous silicon in which an n-type impurity such as phosphorous is highly doped, or silicide. The ohmic contact stripes 161 have a plurality of projections 163, and the projections 163 and the ohmic contact islands 165 are disposed as pairs on the projections 154 of the semiconductor stripes 151.

The side of the semiconductor stripes 151 and the sides of the ohmic contact stripes and islands 161 and 165 are sloped to the substrate 110, and the slope angle is within the range of about 30° to about 80°.

A plurality of data lines 171, a plurality of drain electrodes 175, and a plurality of isolated metal pieces 178 are formed on the ohmic contact stripes and islands 161 and 165 and the gate insulating layer 140.

The data lines 171 transfer data signals and extend substantially in a vertical direction to cross the gate lines 121 and the branch lines and the connections 133e of the storage electrode lines 131. Each data line 171 includes a plurality of source electrodes 173 extending toward the gate electrode 124 and a large end portion 179 for connection with a different layer or an external driving circuit. A data driving circuit (not shown) for generating a data voltage can be mounted on a flexible printed circuit film (not shown) attached on the substrate 110, directly mounted on the substrate 110, or integrated on the substrate 110. When the data driving circuit is integrated on the substrate 110, the data line 171 can be elongated to be connected thereto.

The drain electrode 175 is separated from the data line 171 and faces the source electrode 173 centering on the gate electrode 124. Each drain electrode 175 includes a large one end portion and the other end in a bar shape, and the bar-shaped end portion is partially surrounded by the source electrode 173.

One gate electrode 124, one source electrode 173, and one drain electrode 175 constitute a single thin film transistor (TFT) together with the projection 154 of the semiconductor stripe 151, and a channel of the TFT is formed in the projection 154 between the source electrode 173 and the drain electrode 175. The isolated metal piece 178 is positioned at an upper portion of the gate line 121 near the first storage electrode 133a. Like the gate lines 121, the data lines 171, and the drain electrodes 175, the isolated metal pieces 178 may be made of a low-resistance conductor.

Preferably, the side of the data line 171, the side of the drain electrode 175, and the side of the isolated metal piece 178 are also sloped to the surface of the substrate 110 at a slope angle within the range of about 30° to about 80°.

The ohmic contact stripes and islands 161 and 165 exist only between the lower semiconductor stripes 151 and the upper data lines 171 and the drain electrodes 175, in order to lower contact resistance therebetween.

A passivation layer 180 is formed on the data lines 171 and the isolated metal pieces 178, and on the exposed portion of the semiconductor stripes 151. The passivation layer 180 may be made of an inorganic insulator or an organic insulator, etc., and may have a planarized surface. The inorganic insulator may be, for example, silicon nitride or silicon oxide. The organic insulator may have photosensitivity, and its dielectric constant is preferably 4.0 or less. In this respect, the passivation layer 180 may have a double-layered structure of a lower inorganic layer and an upper organic layer so that it may not do harm to the exposed portion of the projection 154 of the semiconductor stripe 151 while still sustaining the excellent insulating characteristics of the organic layer.

A plurality of pixel electrodes 191, a plurality of overpasses 83, and a plurality of contact assistants 81 and 82 are formed on the passivation layer 180. The pixel electrodes 191, the overpasses 83, and the contact assistants 81 and 82 may be made of a transparent conductive material such as indium tin oxide (ITO) or indium zinc oxide (IZO), or a reflective metal such as Al, Ag, Cr, or their alloys.

Each pixel electrode 191 is physically and electrically connected with a drain electrode 175 via a contact hole 185 and receives a data voltage from the drain electrode 175. The pixel electrode 191, to which the data voltage has been applied, generates an electric field together with a common electrode 270 of the common electrode panel 200 that receives a common voltage, to thereby determine a direction of liquid crystal molecules 310 of the liquid crystal layer 3 therebetween. Polarization of light that transmits through the liquid crystal layer 3 changes depending on the thusly determined direction of the liquid crystal molecules 310. The pixel electrode 191 and the common electrode 270 form a capacitor (referred to hereinafter as “liquid crystal capacitor”) to sustain the applied voltage even after the TFT is turned off.

The pixel electrode 191 overlaps with the storage electrode line 131 including the storage electrodes 133a˜133d. A capacitor formed as the pixel electrode 191 and the drain electrode 175 electrically connected thereto overlap with the storage electrode line 131 and is called a storage capacitor, which strengthens voltage storage capacity of the liquid crystal capacitor.

Each pixel electrode 191 has four primary edges substantially parallel to the gate lines 121 or the data lines 171, and has a substantially rectangular shape with chamfered corners. The chamfered hypotenuse of the pixel electrode 191 makes an angle of about 45° to the gate line 121. The pixel electrode 191 includes a central cutout 91, a lower cutout 92a, and an upper cutout 92b, and is divided into a plurality of partitions by these cutouts 91 to 92b. The cutouts 91 to 92b are substantially inversion-symmetrical to a virtual horizontal central line that bisects the pixel electrode 191.

The lower and upper cutouts 92a and 92b slantingly extend substantially from the right side of the pixel electrode 191 to the left side thereof, and overlap with the third and fourth storage electrodes 133c and 133d, respectively. The lower and upper cutouts 92a and 92b are positioned at lower and upper portions centering on a horizontal central line of the pixel electrode 191. The lower and upper cutouts 92a and 92b extend vertically at an angle of about 45° to the gate lines 121.

The central cutout 91 extends along the horizontal central line of the pixel electrode 191 and has an entrance at the right side. The entrance of the central cutout 91 has a pair of oblique sides substantially parallel to the lower and upper cutouts 92a and 92b, respectively. The central cutout 91 includes horizontal portions and a pair of slant portions connected thereto. The horizontal portions extend short along the horizontal central line of the pixel electrode 191, and the pair of slanted portions extend from the horizontal portions toward the right side of the pixel electrode 191 such that they are substantially parallel to the lower and upper cutouts 92a and 92b.

Accordingly, the lower portion of the pixel electrode 191 is divided into two regions by the lower cutout 92a, and the upper portion of the pixel electrode 191 is also divided into two regions by the upper cutout 92b. In this case, the number of regions or the number of cutouts may differ depending on design factors such as the size of the pixel electrode 191, the length ratio of the horizontal side and the vertical side of the pixel electrode 191, and the type of characteristics of the liquid crystal layer 3.

The overpasses 83 traverse the gate lines 121 and are connected with an exposed portion of the storage electrode line 131 and an exposed end portion of the free end of the first storage electrode 133a via contact holes 183a and 183b, which are positioned at mutually opposite sides with the gate line 121 interposed therebetween. The storage electrode lines 131 including the storage electrodes 133a and 133b can be used for repairing a defective gate line 121, a defective data line 171, or a defective TFT together with the overpasses 83.

The contact assistants 81 and 82 are connected with the end portion 129 of the gate line 121 and the end portion 179 of the data line 171 via the contact holes 181 and 182. The contact assistants 81 and 82 complement adhesion of the end portion 129 of the gate line 121 and the end portion 179 of the data line 171 with an external device, and protect them.

The common electrode display panel 200 will now be described with reference to FIGS. 2 to 4.

A light blocking member 220 is formed on an insulating substrate 210 made of transparent glass or plastic. The light blocking member 220 is also called a black matrix, and it prevents light leakage between pixel electrodes 191. The light blocking member 220 has a plurality of openings 225 that face the pixel electrodes 191 and have the almost same shape as the pixel electrodes 191. The light blocking member 220 may include a portion corresponding to the gate lines 121 and the data lines 171 and a portion corresponding to the TFTs.

A plurality of color filters 230 are also formed on the substrate 210. The color filters 230 exist mostly within regions surrounded by the light blocking members 220, and may extend long in a vertical direction along the rows of pixel electrodes 191. Each color filter 230 can display one of the three primary colors of red, green, and blue.

An overcoat 250 is formed on the color filters 230 and the light blocking members 220. The overcoat 250 may be made of an (organic) insulator, and it prevents the color filters 230 from being exposed and provides a planarized surface. The overcoat 250 can be omitted in one embodiment.

The common electrode 270 is formed on the overcoat 250. The common electrode 270 may be made of a transparent conductor such as ITO or IZO, and includes a plurality of cutouts 71, 72a, and 72b.

A set of cutouts 71, 72a, and 72b face a single pixel electrode 191 and includes a central cutout 71, a lower cutout 72a and an upper cutout 72b. The cutouts 71, 72a, and 72b are disposed between the adjacent cutouts 91, 92a, and 92b of the pixel electrode 191 or between the cutouts 92a and 92b and the chamfered oblique sides. The cutouts 71, 72a, and 72b include at least one slant portion extending substantially parallel to the lower cutout 92a or the upper cutout 92b. The cutouts 71, 72a, and 72b are substantially inversion-symmetrical to the horizontal central line of the pixel electrode 191.

The lower and upper cutouts 72a and 72b include a slant portion, a horizontal portion, and a vertical portion, respectively. The slant portions extend substantially from the upper or lower side to the left side. The horizontal and vertical portions extend from the respective ends of the slant portions and overlap with the side of the pixel electrode 191 along the side of the pixel electrode, and make an obtuse angle with the slant portions.

The central cutout 71 includes a central horizontal portion, a pair of slant portions, and a pair of end vertical portions. The central horizontal portion extends substantially from the left side of the pixel electrode 191 to the right side along the horizontal central line of the pixel electrode 191. The pair of slant portions extends from the end of the central horizontal portion toward the right side of the pixel electrode 191 at an obtuse angle so as to be substantially parallel to the lower and upper cutouts 72a and 72b. The end vertical portions extend from the respective ends of the slant portions and overlap with the pixel electrode 191 along the right side of the pixel electrode 191, and make an obtuse angle to the slant portions.

The number of cutouts may vary depending on design factors, and the light blocking member 220 can overlap with the cutouts 71, 72a, and 72b to prevent light leakage at or around the cutouts 71, 72a, and 72b.

When the common voltage is applied to the common electrode 270 and the data voltage is applied to the pixel electrode 191, an electric field substantially perpendicular to the surface of the display panels 100 and 200 is generated. In response to the electric field, the liquid crystal molecules 310 change their direction such that their longer axes are perpendicular to the direction of the electric field.

The cutouts 71 to 72b and 91 to 92b of the field generating electrodes 191 and 270 and the sides of the pixel electrode 191 distort the electric field to create a horizontal component for determining a slant direction of the liquid crystal molecules 310. The horizontal component of the electric field is substantially perpendicular to the sides of the cutouts 71 to 72b and 91 to 92b and the sides of the pixel electrode 191.

With reference to FIG. 3, a set of cutouts 71 to 72b and 91 to 92b divide the pixel electrode 191 into a plurality of sub-regions, and each region has two primary edges making an oblique angle to a primary edge of the pixel electrode 191. The primary edges of each sub-region form an angle of about 45 degrees with polarization axes of polarizers 12 and 22.

Liquid crystal molecules 310 on each sub-region mostly incline to be perpendicular to the primary edges, namely, substantially in four directions. By varying the directions in which the liquid crystal molecules 310 incline, a reference viewing angle of the LCD device can increase.

The shape and disposition of the cutouts 71 to 72b and 91 to 92b may be modified variably.

At least one of the cutouts 71 to 72b and 91 to 92b may be substituted by a protrusion (not shown) or a depression (not shown). The protrusion may be made of an organic material or an inorganic material, and may be disposed on an upper or lower portion of the field generating electrodes 191 and 270.

Alignment layers 11 and 21 are coated on an inner surface of the display panels 100 and 200, respectively, and they may be vertical alignment layers.

The polarizers 12 and 22 are provided on an outer surface of the display panels 100 and 200, respectively, and polarization axes X and Y of the two polarizers 12 and 22 are perpendicular to each other, and preferably make an angle of substantially 45° to the slant cutouts 92a and 92b and the slant portions of the cutouts 71 to 72b. In the case of a reflective LCD, one of the two polarizers 12 and 22 can be omitted.

The LCD according to an embodiment of the present invention may further include a phase retardation film (not shown) for compensating delay of the liquid crystal layer 3. The LCD may include a backlight unit (not shown) for providing light to the polarizers 12 and 22, the phase retardation film, the display panels 100 and 200, and the liquid crystal layer 3.

The liquid crystal layer 3 has negative dielectric anisotropy, and liquid crystal molecules 310 in the liquid crystal layer 3 are aligned such that their longer axes are substantially perpendicular to the surfaces of the two display panels 100 and 200 in a state that there is no electric field. Accordingly, incident light is blocked, rather than passing through the crossed polarizers.

As aforementioned, the liquid crystal layer 3 includes the liquid crystal composition including the polar compound having dielectric anisotropy and the neutral compound that does not have dielectric anisotropy.

A description of the polar compound and the neutral compound are the same as that above, so it will be omitted.

Therefore, by controlling the liquid crystal molecules and the composition ratio, the cost of the liquid crystal material can be reduced while sustaining the physical characteristics such as the dielectric anisotropy, the refractive anisotropy, and the rotation viscosity, compared with the related art liquid crystal composition. In addition, the residual image of the LCD can be improved.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal composition, comprising:
a first class including a liquid crystal compound having at least two fluorine atoms and expressed by Chemical Formulas I or II shown below, 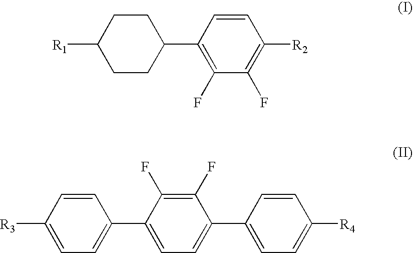
wherein R₁ to R₄ are terminal groups and each of R₁ to R₄ is one of a C₁ to C₁₀ alkyl group and alkoxy group; and
a second class including a liquid crystal compound that has a single fluorine atom or that does not have a fluorine atom, the second class including at least one of liquid crystal compounds expressed by Chemical Formulas III and IV shown below, 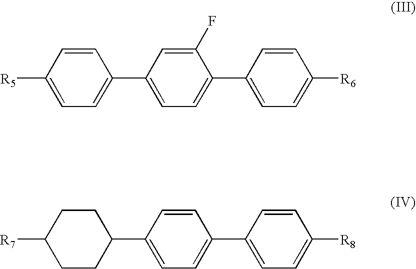
wherein R₅ to R₈ are terminal groups and each of R₅ to R₈ is one of a C₁ to C₁₀ alkyl group, alkoxy group, and alkenyl group.

2. The composition of claim 1, wherein each of the first class and the second class is included at about 10 wt % to about 90 wt % of the total content of the liquid crystal composition.

3. The composition of claim 2, wherein the liquid crystal compound expressed by Chemical Formula I is included at about 20 wt % to about 40 wt % of the total content of the liquid crystal composition, the liquid crystal compound expressed by Chemical Formula II is included at about 1 wt % to about 15 wt % of the total content of the liquid crystal composition, and the liquid crystal compounds expressed by Chemical Formulas III and IV are included at about 15 wt % of the total content of the liquid crystal composition, respectively.

4. The composition of claim 1, wherein the first class further includes at least one of liquid crystal compounds expressed by Chemical Formulas V and VI shown below: 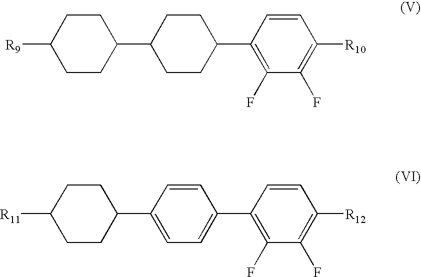
wherein R₉ to R₁₂ are terminal groups and each of R₉ to R₁₂ is one of a C₁ to C₁₀ alkyl group and alkoxy group.

5. The composition of claim 4, wherein the liquid crystal compound expressed by Chemical Formula V is included at about 40 wt % or less of the total content of the liquid crystal composition, and the liquid crystal compound expressed by Chemical Formula VI is included at about 20 wt % or less of the total content of the liquid crystal composition.

6. The composition of claim 5, wherein the second class further includes at least one of liquid crystal compounds expressed by Chemical Formulas VII to XI shown below: 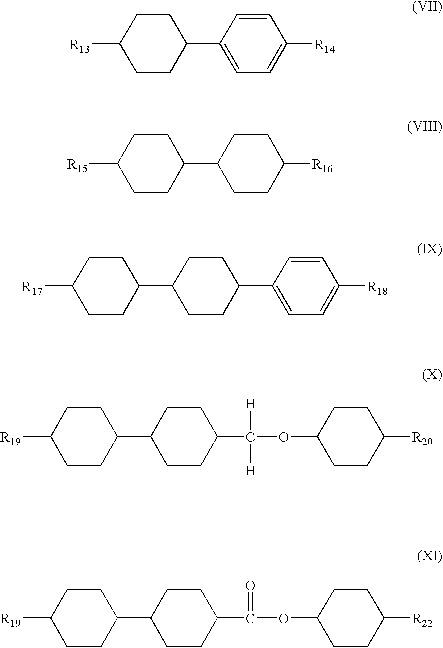
wherein R₁₃ to R₂₂ are terminal groups and each of R₁₃ to R₂₂ is one of a C₁ to C₁₀ alkyl group, alkoxy group, and alkenyl group.

7. The composition of claim 6, wherein the liquid crystal compound expressed by Chemical Formula VII is included at about 20 wt % or less of the total content of the liquid crystal composition, the liquid crystal compound expressed by Chemical Formula VIII is included at about 30 wt % or less of the total content of the liquid crystal composition, the liquid crystal compound expressed by Chemical Formula IX is included at about 25 wt % or less of the total content of the liquid crystal composition, the liquid crystal compound expressed by Chemical Formula X is included at about 20 wt % or less of the total content of the liquid crystal composition, and the liquid crystal compound expressed by Chemical Formula XI is included at about 10 wt % or less of the total content of the liquid crystal composition.

8. The composition of claim 7, wherein when a liquid crystal compound that does not have an alkenyl group in the terminal group is a first sub-class and a liquid crystal compound that has an alkenyl group in the terminal group is a second sub-class, the second sub-class being included at about 7 wt % or less of the total content of the first class and the second class.

9. The composition of claim 8, wherein the liquid crystal composition does not have the second sub-class.

10. The composition of claim 1, wherein the composition has the dielectric anisotropy of about −2.7 to −5.8, the refractive anisotropy of 0.075 to 0.109, and rotation viscosity of 87 mPa·s to 165 mPa·s.

11. A liquid crystal display (LCD), comprising:
a first substrate;
a second substrate facing the first substrate;
a pair of field generating electrodes formed on at least one of the first and second substrates; and
a liquid crystal layer interposed between the first and second substrates,
wherein the liquid crystal layer has a liquid crystal composition comprising a first class including a liquid crystal compound having at least two fluorine atoms and expressed by Chemical Formulas I or II shown below, 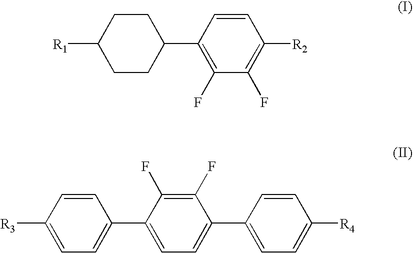
wherein R₁ to R₄ are terminal groups and each of R₁ to R₄ is one of a C₁ to C₁₀ alkyl group, and alkoxy group, and
a second class including a liquid crystal compound that has a single fluorine atom or that does not have a fluorine atom, the second class including at least one of liquid crystal compounds expressed by Chemical Formulas III and IV shown below, 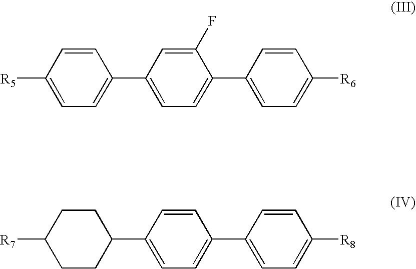
wherein R₅ to R₈ are terminal groups and each of R₅ to R₈ is one of a C₁ to C₁₀ alkyl group, alkoxy group, and alkenyl group.

12. The LCD of claim 11, wherein the liquid crystal compound expressed by Chemical Formula I is included at about 20 wt % to about 40 wt % of the total content of the liquid crystal composition, the liquid crystal compound expressed by Chemical Formula II is included at about 1 wt % to about 15 wt % of the total content of the liquid crystal composition, and the liquid crystal compounds expressed by Chemical Formulas III and IV are included at about 15 wt % of the total content of the liquid crystal composition, respectively.

13. The LCD of claim 11, wherein when a liquid crystal compound that does not have alkenyl group in the terminal group is a first sub-class and a liquid crystal compound that comprises an alkenyl group in the terminal group is a second sub-class, the second sub-class is contained at about 7 wt % or less of a total content of the first class and the second class.

14. The LCD of claim 13, wherein the liquid crystal composition does not have the second sub-class.

15. The LCD of claim 11, wherein the liquid crystal composition has the dielectric anisotropy of about −2.7 to −5.8, the refractive anisotropy of 0.075 to 0.109, and rotation viscosity of 87 mPa·s to 165 mPa·s.

16. The LCD of claim 11, further comprising:
first and second signal lines that cross each other on the first substrate; and
thin film transistors connected with the first and second signal lines.

17. The LCD of claim 16, further comprising:
an inclination direction determining member for determining the inclination direction of the liquid crystal composition in the liquid crystal layer.

18. The LCD of claim 17, wherein the inclination direction determining member includes a cutout formed in the field generating electrode or a protrusion formed on the field generating electrode.
